(19) United States
(12) Patent Application Publication
(10) Pub. No.: US 2008/0039593 A1
(43) Pub. Date: Feb. 14, 2008

(54) Aqueous, Unsaturated, Amorphous Polyesters that are Modified so as to be Radiation Curable

(75) Inventors: Patrick Glockner, Haltern am See (DE); Lutz Mindach, Bochum (DE)

Correspondence Address: OBLON, SPIVAK, MCCLELLAND MAIER & NEUSTADT, P.C., 1940 DUKE STREET, ALEXANDRIA, VA, 22314, US

(73) Assignee: DEGUSSA GmbH, Duesseldorf (DE)

(21) Appl. No.: 11/814,306

(22) PCT Filed: Nov. 28, 2005
(86) PCT No.: PCT/EP05/56266

§ 371 Date: Oct. 30, 2007

(30) Foreign Application Priority Data
Jan. 19, 2005 (DE) 10 2005 002 388.6

(51) Int. Cl. C08G 63/02

(52) U.S. Cl. 525/450

(57) ABSTRACT

The invention relates to aqueous, unsaturated, amorphous polyesters modified so as to be radiation-curable, a process for the preparation thereof and the use thereof in aqueous, radiation-curable systems.

The invention relates to aqueous, unsaturated, amorphous polyesters modified so as to be radiation-curable, a process for their preparation and their use.

In recent years, radiation-curable coating materials have become increasingly important since, inter alia, the content of volatile organic compounds (VOC) of these systems is low.

The film-forming components have relatively low molecular weights and therefore low viscosity in the coating material, so that high proportions of organic solvents can be dispensed with. Durable coatings are obtained by virtue of the fact that a high molecular weight, polymeric network is formed by, for example, UV light or electron beam-initiated crosslinking reactions after application of the coating material.

In addition to the low molecular weight, film-forming components, so-called reactive diluents, which are generally monofunctional, difunctional or higher-functional acrylate monomers, are added so that the viscosity of the quasi-no-VOC systems is sufficiently low.

Many of the reactive diluents are unsafe for toxicological reasons. In the case of sorptive or open-pore substrates, such as, for example, many wood types, the low molecular weight reactive diluents may penetrate into the substrate and are no longer available for a crosslinking reaction, with the result that delamination and/or exudation can occur.

As a result of the network formation, volume shrinkage occurs owing to the high proportion of low molecular weight compounds, which shrinkage is mentioned in the literature as a reason for poor adhesion of radiation-curable coating materials to different substrates in some cases [Surface Coatings International Part A, 2003/06, pp. 221-228].

Relatively high molecular weight film-forming components are therefore desirable in many applications.

The problem of the high viscosity of high molecular weight compounds is circumvented by using radiation-curable polymers which were dispersed in water, since the viscosity is then independent of the molecular weight of the polymers (K. Buysens, M. Tielemans, T. Randoux, Surface Coatings International Part A, 5 (2003), 179-186).

Unsaturated polyester resins (UP resins) are known. They are prepared by condensation of saturated and unsaturated carboxylic acids or anhydrides thereof with dials. Their properties depend substantially on the type and ratio of the starting materials.

In general, α,β-unsaturated acids are used as carriers of the polymerizable double bonds, primarily maleic acid or the anhydride thereof or fumaric acid; unsaturated dials are of minor importance. The higher the content of double bonds, i.e. the shorter the distance between the double bonds in the chain molecules, the more reactive is the polyester resin. It polymerizes with evolution of heat and high volume shrinkage to give a highly crosslinked and therefore relatively brittle end product. The reactive double bonds in the polyester molecule are therefore “diluted” by incorporation of saturated aliphatic or aromatic dicarboxylic acids by condensation. Alcohol components used are straight-chain and/or branched diols. The individual UP resin types differ not only in the components used for their preparation but also in the ratio of saturated to unsaturated acids, which determines the crosslinking density in the polymerization, the degree of condensation, i.e. the molar mass, the acid number and OH number, i.e. the type of terminal groups in the chain molecules, the monomer content and the type of additives (Ullmann's Encyclopedia of Industrial Chemistry, VOL A21, page 217 et seq., 1992).

UP resins based on dicidol as the diol component are disclosed, for example, in DE 953 117, DE 22 45 110, DE 27 21 989, EP 0 114 208, EP 0 934 988.

The use of unsaturated polyester resins for improving the adhesion is disclosed, for example, in DE 24 09 800, EP 0 114 208 and EP 0 934 988.

DE 953 117 describes a process for the preparation of unsaturated polyesters, wherein unsaturated dicarboxylic acids are reacted with polycyclic, polyhydric alcohols whose hydroxyl groups are distributed over different rings of an expediently condensed ring system. These polyesters can be polymerized with vinyl compounds, such as styrene, alkylstyrene, chlorostyrene, vinylnaphthalene and vinyl acetate, nontacky films then being obtained. In contrast to the dicidol mixture of the isomeric compounds 3,8-bis(hydroxymethyl)tricyclo[5.2.1.0^{2,6}]-decane, 4,8-bis(hydroxymethyl)tricyclo[5.2.1.0^{2,6}]decane and 5,8-bis(hydroxymethyl)tricyclo[5.2.1.0^{2,6}]decane used in the present invention, only an undefined diol having a presumed structure similar to dicidol is used in DE 953 117. In addition, vinyl compounds which contain only one double bond, but not an acrylic double bond, are optionally used there.

A modification of the polyesters with acrylic double bonds is not described.

Aromatic vinyl compounds as described in DE 953 117 can additionally have a disadvantageous effect, for example on stability properties, such as, for example, stabilities to weathering, and it is for this reason that they are scarcely used in high-quality adhesives and/or coating materials. As our own detailed experiments have shown, only an improvement of the nontacky character is achieved with resin-vinyl monomer compositions as described in DE 953 117. The compounds prepared in the present invention are distinguished by the fact that the adhesion of coating materials is improved, in combination with improved corrosion protection, greater hardness, improved gloss and polymer content with the same viscosity of the finish or adhesive and low volume shrinkage during crosslinking and good color stability of the crosslinked polymer.

DE 22 45 110 describes polyester material comprising unsaturated polyesters, vinyl monomers, activators and additives for the production of coatings which can be cured by means of IR radiation, and which are said to improve the grindability, curing properties and stackability. In addition to the remarks on DE 953 117, the present invention is concerned with UV-curable or electron-beam curable adhesives and coating material systems.

Compounds which are described in DE 27 21 989 are accessible only to crosslinking with aminoplasts. The polyester skeleton described there has an exclusively saturated character. Crosslinking via free radical polymerization, which can be initiated by radiation energy, is not possible. Moreover, it is known that the high proportions of terephthalic acid used in DE 27 21 989 have an adverse effect on stability properties, such as, for example, stability to weathering.

The resins claimed in DE-A 102 12 706, EP 0 114 208 and EP 0 934 988 are likewise unsuitable for use in radiation-curable coating materials, since the reactivity with respect to radiation-induced crosslinking is too low.

WO 89/07622 describes acryloylstyrene-containing polyesters and polycarbonates which are stable to radiation and could optionally contain dicidol, for the packaging of, for example, foods, such as fruit juices, soft drinks, wine, etc. The unsaturated polyesters on which the invention is based are free of acylstyryl units and moreover radiation-curable.

Compositions which are likewise not suitable for radiation-induced crosslinking are described in DE 102 05 065. The polyester resins used there contain, instead of the bis(hydroxymethyl)tricyclopentadiene derivatives used in the present invention, only dicyclopentadiene, which is not accessible to direct esterification. Consequently, particularly pressure-resistant and hence expensive reactors have to be used for the preparation, which is not advisable from economic points of view.

DE-A 102004031759.3 describes solutions of unsaturated polyesters in reactive diluents with dicidol in the alcohol component. These unsaturated polyesters can be crosslinked exclusively via the double bonds of the unsaturated carboxylic acids, induced by radiation. It is known that such unsaturated polyesters have a relatively low reactivity with respect to radiation-induced crosslinking reactions, and it is for this reason that a proportion of unsaturated polyesters which contain exclusively unsaturated dicarboxylic acids in the polyester skeleton is increasingly declining for radiation-curable coating materials for economic reasons, for example excessively short throughput times. Moreover, owing to the lower reactivity, it is not possible to obtain by radiation-induced crosslinking polymer networks which meet very high stability requirements (for example with respect to solvents or chemicals). A chemical modification of these polymers for increasing the reactivity with respect to radiation-induced crosslinking reactions, as claimed in the present invention, is not described.

DE 102004049544.0 describes unsaturated polyesters whose reactivity is sufficiently high, but it is not possible to use these systems in aqueous coating materials.

Owing to a lack of hydrophilicity, all products described in the patents are unsuitable for aqueous applications. For economic reasons, rapid curing is desirable since the throughput times are thus short. The products described in the patents mentioned are not sufficiently reactive for a rapid, radiation-induced crosslinking reaction.

DE 102 61 006 and DE 102 61 005 describe aqueous, unsaturated polyesters which, however, can be subjected to radiation-induced crosslinking only via the unsaturated dicarboxylic acids. As already described, the reactivity of unsaturated polyesters with respect to radiation-induced crosslinking reactions is low, with the result that their use in applications which are dependent on high throughputs for economic reasons is limited.

It was an object of the present invention to provide an aqueous, adhesion-improving composition which improves the properties of, for example, aqueous, radiation-curable adhesives and coating materials, such as, for example, the adhesion, and simultaneously has high corrosion protection, great hardness, improved gloss of the coat and a low viscosity. At the same time, the reactivity with respect to the radiation-induced crosslinking reaction should be high.

Surprisingly, it was found that this object can be achieved by the use of aqueous, unsaturated, amorphous polyesters modified so as to be radiation-curable and substantially comprising
A) at least one unsaturated, amorphous polyester comprising at least one α,β-unsaturated dicarboxylic acid component and an alcohol component, the alcohol component comprising a dicidol mixture of the isomeric compounds 3,8-bis(hydroxymethyl)tricyclo[5.2.1.0^{2,6}]decane, 4,8-bis(hydroxymethyl)tricyclo[5.2.1.0^{2,6}]decane and 5,8-bis(hydroxymethyl)tricyclo[5.2.1.0^{2,6}]decane, it being possible for each isomer to be present in a proportion of from 20 to 40% in the mixture, and the sum of the three isomers being from 90 to 100%, and the mixture being present in an amount of at least 5% in the alcohol components of the polyester,
and
B) at least one compound which has at least one ethylenically unsaturated group simultaneously having at least one group reactive toward A),
and
C) at least one compound having at least one hydrophilic and/or potentially hydrophilic group.

The invention therefore relates to aqueous, unsaturated, amorphous polyesters modified so as to be radiation-curable and substantially comprising
A) at least one unsaturated, amorphous polyester comprising at least one α,β-unsaturated dicarboxylic acid component and an alcohol component, the alcohol component comprising a dicidol mixture of the isomeric compounds 3,8-bis(hydroxymethyl)tricyclo[5.2.1.0^{2,6}]decane, 4,8-bis(hydroxymethyl)tricyclo[5.2.1.0^{2,6}]decane and 5,8-bis(hydroxymethyl)tricyclo[5.2.1.0^{2,6}]decane, it being possible for each isomer to be present in a proportion of from 20 to 40% in the mixture, and the sum of the three isomers being from 90 to 100%, and the mixture being present in an amount of at least 5% in the alcohol components of the polyester,
and
B) at least one compound which has at least one ethylenically unsaturated group simultaneously having at least one group reactive toward A),
and
C) at least one compound having at least one hydrophilic and/or potentially hydrophilic group.

The invention furthermore relates to the use of aqueous, unsaturated, amorphous polyesters modified so as to be radiation-curable and substantially comprising
A) at least one unsaturated, amorphous polyester comprising at least one α,β-unsaturated dicarboxylic acid component and an alcohol component, the alcohol component comprising a dicidol mixture of the isomeric compounds 3,8-bis(hydroxymethyl)tricyclo[5.2.1.0^{2,6}]decane, 4,8-bis(hydroxymethyl)tricyclo[5.2.1.0^{2,6}]decane and 5,8-bis(hydroxymethyl)tricyclo[5.2.1.0^{2,6}]decane, it being possible for each isomer to be present in a proportion of from 20 to 40% in the mixture, and the sum of the three isomers being from 90 to 100%, and the mixture being present in an amount of at least 5% in the alcohol components of the polyester,
and
B) at least one compound which has at least one ethylenically unsaturated group simultaneously having at least one group reactive toward A),
and
C) at least one compound having at least one hydrophilic and/or potentially hydrophilic group, as a main component, base component or additional component in aqueous coating materials, adhesives, printing inks and inks, polishes, glazes, pigment pastes, filling compounds, cosmetic articles and/or sealing compounds and insulating materials, in particular for improving adhesion properties, gloss, solvent resistance and resistance to chemicals and the hardness, with simultaneous high reactivity.

The aqueous, unsaturated, amorphous polyesters modified so as to be radiation-curable comprise
a) a content of nonvolatile components of from 20 to 60%
b) a solvent content of from 0 to 20%
c) a viscosity at 20° C. of from 20 to 750 mPa·s.

It has been found that there is universal compatibility of this composition with further components of aqueous, radiation-curable coating materials and/or adhesives and/or sealing compounds. For example, the composition according to the invention can be mixed with aqueous, acrylated polyesters, polyacrylates, polyester-urethanes, epoxyacrylates and/or polyetheracrylates and alkyd resins, ketone/formaldehyde resins, ketone resins and/or unsaturated polyesters.

The compositions according to the invention can be used, for example, as binders in aqueous, radiation-curable coating materials and form coatings which are corrosion-resistant as a result of free radical polymerization. The good adhesion and the possibility of undergoing crosslinking reactions make the resins according to the invention ideal for corrosion protection. In addition, the adhesion to various plastics is improved. In addition to the increase in adhesion, the interlay adhesion bounding layers above and below is also improved. Coating materials which contain an additive according to the invention are also distinguished by high gloss and good leveling. Owing to the high reactivity of the products according to the invention, the use in areas in which high throughput rates during curing are required is advantageous.

The aqueous, unsaturated, amorphous polyesters modified so as to be radiation-curable are produced in particular in aqueous, radiation-curable coating materials, adhesives, laminations, printing inks and inks, polishes, glazes, pigment pastes, filling compounds, cosmetic articles, packaging materials and/or sealing compounds and insulating materials, in particular for improving the adhesion properties and the hardness. Very good adhesion properties with respect to various substrates, for example, metals, mineral substrates, plastics, such as, for example, polyethylene, polypropylene or polycarbonate, polymethyl methacrylate or ABS, but also with respect to glass, paper, board, cardboard, wood, leather and textiles as well as ceramics, are obtained.

The aqueous, radiation-curable, adhesion-improving products according to the invention, comprising modified, unsaturated, amorphous polyesters, are described in more detail below.

The unsaturated, amorphous polyester resins of component A) are obtained by reacting an alcohol component and an acid component.

According to the invention, the alcohol component used is a dicidol mixture of the isomeric compounds 3,8-bis-(hydroxymethyl)tricyclo[5.2.1.0^{2,6}]decane, 4,8-bis-(hydroxymethyl)tricyclo[5.2.1.0^{2,6}]decane and 5,8-bis-(hydroxymethyl)tricyclo[5.2.1.0^{2,6}]decane, it being possible for each isomer to be present in a proportion of from 20 to 40% in the mixture, and the sum of the three isomers being from 90 to 100%, preferably from 95 to 100%, and the mixture is present in an amount of at least 5% in the alcohol component of the polyester. The isomer content of the dicidol mixture can be determined qualitatively and quantitatively, for example by GC analysis or quantitatively by separation by means of preparative GC or HPLC and subsequent NMR spectroscopy. All appropriate isomers of dicidol in the 9-position are just as suitable but, owing to the mirror symmetry of the abovementioned isomers, as well as the cis- and trans-isomers, are not distinguishable under normal circumstances relating to practice.

Moreover, the dicidol mixture may contain up to 10% of further isomers of dicidol and/or trimeric and/or higher isomeric diols of the Diels-Alder reaction product of cyclopentadiene. Advantageously, the alcohol component comprises 20%, preferably 50%, particularly preferably 90%, very particularly preferably 100%, of dicidol mixture, this particularly preferably containing from 95 to 100% of the abovementioned three isomeric compounds.

In addition to the dicidol mixture, the alcohol component may contain further linear and/or branched, aliphatic and/or cycloaliphatic and/or aromatic diols and/or polyols. Preferably used additional alcohols are ethylene glycol, 1,2- and/or 1,3-propanediol, diethylene, dipropylene, triethylene or tetraethylene glycol, 1,2- and/or 1,4-butanediol, 1,3-butylethylpropanediol, 1,3-methylpropanediol, 1,5-pentanediol, cyclohexanedimethanol, glycerol, hexanediol, neopentylglycol, trimethylolethane, trimethylolpropane and/or pentaerythritol and bisphenol A, B, C and F, norbornylene glycol, 1,4-benzyldimethanol and -ethanol and 2,4-dimethyl-2-ethylhexane-1,3-diol.

The unsaturated, amorphous polyester resins contain, as a starting acid component, at least one α,β-unsaturated dicarboxylic acid. The unsaturated polyester resins preferably contain citraconic, fumaric, itaconic, maleic and/or mesaconic acid.

Aromatic and/or aliphatic and/or cycloaliphatic monocarboxylic acids and/or dicarboxylic acids and/or polycarboxylic acids may additionally be present, such as, for example, phthalic acid, isophthalic acid, terephthalic acid, 1,4-cyclohexanedicarboxylic acid, succinic acid, sebacic acid, methyltetrahydrophthalic acid, methylhexahydrophthalic acid, hexahydrophthalic acid, tetrahydrophthalic acid, dodecanedioic acid, adipic acid, azelaic acid, isononanoic acid, 2-ethylhexanoic acid, pyromellitic acid and/or trimellitic acid (anhydride). Hexahydrophthalic acid, tetrahydrophthalic acid, dodecanedioic acid, adipic acid, azelaic acid, trimellitic acid (anhydride) and/or phthalic acid (anhydride) are preferred.

The acid components may partly or completely comprise anhydrides and/or alkyl esters, preferably methyl esters.

In general, the alcohol component is present in a molar ratio of 0.5 to 2.0:1 relative to the acid component, preferably 0.8 to 1.5:1. The reaction of the alcohol component particularly preferably takes place in a molar ratio of 1.0 to 1.1:1 relative to the acid component.

The unsaturated, amorphous polyesters may have an acid number of from 1 to 200 mg KOH/g, preferably from 1 to 150, particularly preferably from 1 to 100, mg KOH/g and an OH number of from 1 to 200 mg KOH/g, preferably from 1 to 150, particularly preferably from 1 to 100, mg KOH/g.

The glass transition temperature, Tg, of the unsaturated, amorphous polyesters modified so as to be radiation-curable varies from −30 to +100° C., preferably from −20 to +80° C., particularly preferably from −10 to +60° C.

In a preferred embodiment I of component A), the unsaturated polyesters (UP resins) comprise an alcohol component comprising at least 90%, preferably 95%, particularly preferably 100%, of the dicidol mixture of the isomeric compounds 3,8-bis(hydroxymethyl)-tricyclo[5.2.1.0^{2,6}]decane, 4,8-bis(hydroxymethyl)-tricyclo[5.2.1.0^{2,6}]decane and 5,8-bis(hydroxymethyl)-tricyclo[5.2.1.0^{2,6}]decane and comprise fumaric acid and/or maleic acid (anhydride) in a diol/acid ratio of 0.9 to 1.1:1. In a further preferred embodiment II of component A), the polyesters contain the above-mentioned starting components as under I but additionally further acids selected from adipic acid, trimellitic acid (anhydride), dodecanedioic acid, 1,2-cyclohexane-dicarboxylic acid and/or phthalic acid (anhydride), it being possible for the ratio of the α,β-unsaturated acid to the additional acid to vary from 2:1 to 1:4. The ratios of about 1:1 to 1:2 are preferred. These polyesters generally have acid numbers of from 1 to 200 mg KOH/g, preferably 1-150 mg KOH/g, particularly preferably 1-100 mg KOH/g, OH numbers of from 1 to 200 mg KOH/g, preferably 1-150 mg KOH/g, particularly preferably 1-100 mg KOH/g, and a Tg of from −30 to +100° C., preferably from −20 to +80° C., particularly preferably from −10 to +60° C.

(Meth)acrylic acid derivatives, such as, for example, (meth)acryloyl chloride, glycidyl (meth)acrylate, (meth)acrylic acid and/or the low molecular weight alkyl esters and/or anhydrides thereof, alone or as a mixture, are suitable as component B). Amino- or hydroxyalkyl (meth)acrylates whose alkyl spacers have from one to 12, preferably from 2 to 8, particularly preferably from 2 to 6, carbon atoms are furthermore preferred.

Isocyanates which have an ethylenically unsaturated group, such as, for example, (meth)acryloyl isocyanate, α,α-dimethyl-3-isopropenylbenzyl isocyanate, (meth)acryloylalkyl isocyanate having alkyl spacers which have from one to 12, preferably from 2 to 8, particularly preferably from 2 to 6, carbon atoms, such as, for example, methacryloylethyl isocyanate or methacryloylbutyl isocyanate, are also suitable. Moreover, reaction products of amino- or hydroxyalkyl (meth)acrylates whose alkyl spacers have from one to 12, preferably from 2 to 8, particularly preferably from 2 to 6, carbon atoms, and diisocyanates, such as, for example, cyclohexane diisocyanate, methylcyclohexane diisocyanate, ethylcyclohexane diisocyanate, propylcyclohexane diisocyanate, methyldiethylcyclohexane diisocyanate, phenylene diisocyanate, toluene dilsocyanate, bis-(isocyanatophenyl)methane, propane diisocyanate, butane diisocyanate, pentane diisocyanate, hexane diisocyanate, such as hexamethylene diisocyanate (HDI) or 1,5-diisocyanato-2-methylpentane (MPDI), heptane diisocyanate, octane diisocyanate, nonane diisocyanate, such as 1,6-diisocyanato-2,4,4-trimethylhexane or 1,6-diisocyanato-2,2,4-trimethylhexane (TMDI), nonane triisocyanate, such as 4-isocyanatomethyl-1,8-octane diisocyanate (TIN), decane di- and triisocyanate, undecane di- and triisocyanate, dodecane di- and triisocyanates, isophorone diisocyanate (IPDI), dicyclohexylmethane 4,4′-diisocyanate (H₁₂MDI), isocyanatomethylmethylcyclohexyl isocyanate, 2,5, (2,6)-bis(isocyanatomethyl)bicyclo[2.2.1]heptane (NBDI), 1,3-bis(isocyanatomethyl)cyclohexane (1,3-H₆-XDI) or 1,4-bis(isocyanatomethyl)cyclohexane (1,4-H₆-XDI) alone or as a mixture, have also proven advantageous as component B). The reaction products of hydroxyethyl acrylate and/or hydroxyethyl methacrylate with isophorone diisocyanate and/or H₁₂MDI and/or HDI in the molar ratio of 1:1 may be mentioned as examples.

Another preferred class of polyisocyanates are the compounds prepared by dimerization, trimerization, allophanatization, biuretization and/or urethanization of the simple diisocyanates and having more than two isocyanate groups in the molecule, for example the reaction product of these simple diisocyanates, such as, for example, IPDI, HDI and/or H₁₂MDI, with polyhydric alcohols (for example glycerol, trimethylol-propane, pentaerythritol) or polyfunctional polyamines or the triisocyanurates, obtainable by trimerization of the simple diisocyanates, such as, for example, IPDI, HDI and H₁₂MDI.

Depending on the ratio of components A) and B) to one another and the type of component B), compounds which have a low to high functionality are obtained. By the choice of the starting materials, it is also possible to adjust the subsequent hardness of the crosslinked film. If, for example, component A) is reacted with α,α-dimethyl-3-isopropenylbenzyl isocyanate in the molar ratio 1:1.5, products having a higher hardness than that obtained by using (meth)acryloylethyl isocyanate and/or hydroxyethyl acrylate-hexamethylene diisocyanate adducts are obtained; the flexibility is, however, then lower. It is also to be found that the reactivity of ethylenically unsaturated compounds having a low degree of steric hindrance—such as, for example, of hydroxyethyl acrylate—is higher than in the case of those which are sterically hindered, such as, for example, α,α-dimethyl-3-isopropenylbenzyl isocyanate.

The transfer of the polymers into the aqueous phase can be effected directly and without the aid of further additives, possibly after the neutralization thereof with suitable neutralizing agents, particularly when free acid groups are present. The free acid groups are obtainable, for example, by partial reaction of, for example, di-, tri- or polycarboxylic acids, such as, for example, pyromellitic acid and/or trimellitic acid, as component C).

However, it is also possible to effect a hydrophilic modification, for example by reacting the hydroxy-functional reaction product of A) and B) with a component C), such as, for example, a (poly)isocyanate and/or mixtures of different (poly)isocyanates with compounds which have at least one function reactive toward isocyanate groups, such as, for example, hydroxyl or amino groups, in addition to hydrophilic or potentially hydrophilic groups—i.e. those groups which become hydrophilic only after neutralization—and are described in EP 0839847. Examples of such compounds for the hydrophilic modification of (poly)isocyanates are amino acids, hydroxysulfonic acids, aminosulfonic acids and hydroxycarboxylic acids. Dimethylolpropionic acid and/or 2-[(2-aminoethyl)amino]ethanesulfonic acid or derivatives thereof are preferably used (component C)).

The hydrophilic modification can also be carried out with nonionic groups or already neutralized compounds.

Suitable polisocyanates for the preparation of C) are preferably di- to tetrafunctional polyisocyanates. Examples of these are cyclohexane diisocyanate, methylcyclohexane diisocyanate, ethylcyclohexane diisocyanate, propylcyclohexane diisocyanate, methyldiethylcyclohexane diisocyanate, phenylene diisocyanate, toluene diisocyanate, bis(isocyanato-phenyl)methane, propane diisocyanate, butane diisocyanate, pentane diisocyanate, hexane diisocyanate, such as hexamethylene diisocyanate (HDI) or 1,5-diisocyanato-2-methylpentane (MPDI), heptane diisocyanate, octane diisocyanate, nonane diisocyanate, such as 1,6-diisocyanato-2,4,4-trimethylhexane or 1,6-diisocyanato-2,2,4-trimethylhexane (TMDI), nonane triisocyanate, such as 4-isocyanatomethyl-1,8-octane diisocyanate (TIN), decane di- and triisocyanate, undecane di- and triisocyanate, dodecane di- and triisocyanates, isophorone diisocyanate (IPDI), dicyclohexylmethane 4,4′-diisocyanate (H₁₂MDI), isocyanatomethylmethylcyclohexyl isocyanate, 2,5(2,6)-bis(isocyanatomethyl)bicyclo[2.2.1]heptane (NBDI), 1,3-bis(isocyanatomethyl)cyclohexane (1,3-H₆-XDI) or 1,4-bis(isocyanatomethyl)cyclohexane (1,4-H₆-XDI), alone or as a mixture.

Another preferred class of polyisocyanates comprises the compounds prepared by dimerization, trimerization, allophanatization, biuretization and/or urethanization of the simple diisocyanates and having more than two isocyanate groups per molecule, for example the reaction products of these simple diisocyanates, such as, for example, IPDI, TMDI, HDI and/or H₁₂MDI, with polyhydric alcohols (e.g. glycerol, trimethylolpropane or pentaerythritol) or polyfunctional polyamines or the triisocyanurates which are obtainable by trimerization of the simple diisocyanates, such as, for example, IPDI, HDI and H₁₂MDI.

A hydrophilically modified polyisocyanate (C) obtained from dimethylolpropionic acid and/or 2-[(2-aminoethyl)amino]ethanesulfonic acid or their derivatives and IPDI and/or H₁₂MDI and/or HDI in the molar ratio 1:2 is particularly preferred.

It is also possible to effect a nonionogenic hydrophilization, for example via suitable polyetherpolyols, which can be reacted, for example, with abovementioned polyisocyanates and the components A) and B).

The compositions according to the invention may also contain auxiliaries and additives, such as, for example, inhibitors, organic solvents, surface-active substances, oxygen scavengers and/or free radical scavengers, catalysts, light stabilizers, color brighteners, photosensitizers, thixotropic agents, antiskinning agents, antifoams, antistatic agents, thickeners, thermoplastic additives, dyes, pigments, fireproof treatments, internal lubricants, fillers and/or blowing agents.

The polyesters according to the invention of component A) are prepared by (semi)continuous or batchwise esterification and condensation of the starting acids and starting alcohols in a one-stage or multistage procedure. The reaction of the polyester A) with the components C) and B) or, in the converse sequence, with the components B) and C) is then effected. The reaction can be effected in the melt or in solution in a suitable solvent.

The invention also relates to a process for the preparation of aqueous, unsaturated, amorphous polyesters modified so as to be radiation-curable and substantially comprising
A) at least one unsaturated, amorphous polyester comprising at least one α,β-unsaturated dicarboxylic acid component and an alcohol component, the alcohol component comprising a dicidol mixture of the isomeric compounds 3,8-bis(hydroxymethyl)tricyclo[5.2.1.0^{2,6}]decane, 4,8-bis(hydroxymethyl)tricyclo[5.2.1.0^{2,6}]decane and 5,8-bis(hydroxymethyl)tricyclo[5.2.1.0^{2,6}]decane, it being possible for each isomer to be present in a proportion of from 20 to 40% in the mixture, and the sum of the three isomers being from 90 to 100%, and the mixture being present in an amount of at least 5% in the alcohol components of the polyester,
and
B) at least one compound which has at least one ethylenically unsaturated group simultaneously having at least one group reactive toward A),
and
C) at least one compound having at least one hydrophilic and/or potentially hydrophilic group,
   by reaction of the starting components for the preparation of component A) at a temperature of from 150 to 270° C., preferably in an inert gas atmosphere, the inert gas having an oxygen content of less than 50 ppm, and subsequent reaction with the components C) and B) or, in the converse order, with the components B) and C) in the melt or in solution in a suitable, organic solvent which—if desired—can be separated off by distillation after its preparation, at temperatures of from 20 to 230° C., preferably from 40 to 200° C., particularly preferably from 50 to 180° C., and subsequent dispersing of the optionally neutralized resin in water.

Suitable auxiliary solvents which are used are low-boiling, inert solvents which form no miscibility gaps with water, at least over wide ranges, have a boiling point below 100° C. at atmospheric pressure and, if desired, can therefore be readily separated off by distillation to a residual content of less than 2% by weight and in particular of less than 0.5% by weight, based on the finished dispersion or aqueous solution, and can be reused. Suitable solvents of this type are, for example, acetone, methyl ethyl ketone or tetrahydrofuran. Higher-boiling solvents, such as, for example, n-butylglycol, di-n-butylglycol and N-methylpyrrolidone are in principle also suitable and subsequently remain in the dispersion. If required, it is possible to use reactive diluents, i.e. compounds which have a relatively low viscosity and at the same time can undergo crosslinking reactions initiated by radiation. These compounds likewise remain in the subsequent aqueous dispersion.

In the case of potentially hydrophilic groups, a suitable neutralizing agent can be added to the products according to the invention, with the result that water-dilutable, water-dispersible or water-soluble products are then obtained.

In the case of carboxyl groups as potentially hydrophilic groups, the neutralization of the resins prepared according to the invention can be effected with inorganic and/or organic bases, such as, for example, ammonia or organic amines. Primary, secondary and/or tertiary amines, such as, for example, ethylamine, propylamine, dimethylamine, dibutylamine, cyclohexylamine, benzylamine, morpholine, piperidine and triethanolamine, are preferably used. Volatile, tertiary amines, in particular dimethylethanolamine, diethylethanolamine, 2-dimethylamino-2-methyl-1-propanol, triethylamine, tripropylamine and tributylamine are particularly preferred in the case of anionic potential groups. So-called cationic potential ionogenic groups can be neutralized with inorganic and/or organic acids, such as, for example, acetic acid, formic acid, phosphoric acid, hydrochloric acid, etc.

The degree of neutralization depends on the content of neutralizable groups in the hydrophilically modified resin and is preferably from 30 to 130% (from 0.3 to 1.3) of the amount of neutralization, preferably from 40 to 100% (from 0.4 to 1), particularly preferably from 60 to 100% (from 0.6 to 1), which is required for stoichiometric neutralization.

Before the dispersing, the reaction product of A), B) and C) can optionally be combined with further resins which have been rendered hydrophilic and/or resins which have not been rendered hydrophilic and/or further components and then dispersed together.

In a preferred embodiment I, the compound which has at least one ethylenically unsaturated group and at the same time at least one group reactive toward A) (component B)) is added to a solution or melt of component A) which contains a partially reacted di-, tri- or polycarboxylic acid as component C), optionally in the presence of a suitable catalyst.

It has proven advantageous to react from 2 to 100, preferably from 5 to 100, particularly preferably from 10 to 100, % of the OH groups of component A) with component B).

The temperature of the reaction is chosen according to the reactivity of the components with one another. Temperatures of from 20 to 230° C., preferably from 40 to 200° C., particularly preferably from 50 to 180° C., have proven useful in these reaction steps.

After neutralization with a suitable neutralizing agent, the neutralized reaction product can be dispersed in water. Alternatively, dispersions can be effected directly in a water/neutralizing agent mixture.

The optionally contained solvent can, if desired, be separated off after the end of the reaction, a solution to dispersion of the product according to the invention then as a rule being obtained.

In a preferred embodiment II, the compound which has at least one ethylenically unsaturated group and at the same time at least one group reactive toward A) (component B)) is added to a solution or melt of component A), optionally in the presence of a suitable catalyst.

It has proven advantageous to react from 2 to 90, preferably from 5 to 80, particularly preferably from 10 to 75, % of OH groups of component A) with component B).

Simultaneously therewith, component C), for example an adduct of 2 mol of diisocyanate and 1 mol of dihydroxycarboxylic acid, such as, for example, dimethylolpropionic acid and/or 2-[(2-aminoethyl)amino]ethanesulfonic acid or derivatives thereof, can be prepared, optionally with the use of a suitable solvent and of a suitable catalyst.

The separately prepared products are combined and reacted.

It has proven advantageous to react 1 mol of the reaction product of components A) and B)—based on Mₙ—with from 0.5 to 1.5 mol, particularly preferably from 1 to 1 mol of component C).

The temperature of the reaction is chosen according to the reactivity of the components with one another. Temperatures of from 20 to 230° C., preferably from 40 to 200° C., particularly preferably from 50 to 180° C., have proven useful in these reaction steps.

If required, the reaction can be stopped by adding an amine or alcohol. Depending on the type of this component, further properties, such as, for example, the compatibility with other raw materials, e.g. pigments, can be varied.

If necessary, neutralization can first be effected with a suitable neutralizing agent, and the neutralized reaction product can then be dispersed in water. Alternatively, dispersing can be effected directly in a water/neutralizing agent mixture.

The optionally contained solvent can, if desired, be separated off after the end of the reaction, a solution to dispersion of the product according to the invention then as a rule being obtained.

The resin dispersions according to the invention are suitable as the main component, base component or additional component in aqueous radiation-curable coating materials, adhesives, printing inks and inks, polishes, glazes, pigment pastes, filling compounds, cosmetic articles and/or sealing compounds and insulating materials, since they are distinguished by rapid curing rates, high blocking resistances and hardness, high gloss and relatively low viscosities and by very good adhesion properties and, associated therewith, have very good corrosion protective effects. Articles can be finished with the aqueous, unsaturated, amorphous polyesters modified so as to be radiation-curable.

In the presence of suitable photoinitiators, optionally in the presence of suitable photosensitizers, after evaporation of the water, these resins can be converted by irradiation into polymeric, insoluble networks which, depending on the content of ethylenically unsaturated groups, give elastomers to thermosetting plastics.

### EXAMPLES

The following examples are intended to explain the invention further but not to limit its range of use: Starting component dicidol mixture in the isomer ratio of approximately 1:1:1.

### Example I

Dodecanedioic acid and fumaric acid (ratio 0.4:0.6) are reacted with dicidol in the ratio 1:1.15 at 180° C. in a nitrogen atmosphere until an acid number of 12 mg KOH/g is reached. For this purpose, the fumaric acid is first esterified with dicidol for one hour and the dodecanedioic acid is then added. The resin is dissolved in acetone to give a 50% strength solution. The OH number is 62 mg KOH/g.

The OH groups of the polyester are reacted with a 1:1 mixture comprising a 1:1 adduct of hydroxyethyl acrylate and isophorone diisocyanate and a 1:2 adduct of dimethylolpropionic acid and isophorone diisocyanate at 55° C. in the presence of 0.1% of dibutyltin dilaurate until an NCO number of less than 0.1% is reached. The polymer content is then adjusted exactly to 50% with acetone.

4.7 g of dimethylaminoethanol are then added to 250 g of the adduct at 30° C., and dispersing is then effected with 320 g of demineralized water with vigorous stirring (12 m/s circumferential speed). After about 10 minutes, 4.6 g of Darocur 1173 (photoinitiator from Ciba) are added with moderate stirring, and the acetone is removed from the mixture at elevated temperature and under slight vacuum.

A storage-stable, slightly turbid dispersion having a pH of 8.6, a solids content of 32.5 and a viscosity of about 350 mPa·s is obtained.

The dispersion is provided with a polyurethane dispersion in the ratio 1:1 and applied to a glass sheet or a Bonder metal sheet, and the solvent is evaporated at elevated temperature (30 min, 80° C.). The films are then cured by means of UV light (medium-pressure mercury lamp, 70 W, optical filter 350 nm) for about 12 sec.

The films are resistant to premium grade gasoline and methyl ethyl ketone.

Adhesion to galvanized steel sheet (DIN 53151): 0

Beech wood indentation hardness (DIN 53153): 79

Erichsen cupping (DIN 53156): >9.5 mm

König pendulum hardness (DIN EN ISO 1522): 118 s

### Example II

### II.1.) Polyester Preparation

1.1 mol of adipic acid are reacted with 3.4 mol of dicidol at 210° C. in a nitrogen atmosphere until an acid number of less than 5 mg KOH/g is reached. 1.1 mol of fumaric acid and 0.02% of hydroquinone are then added. After stirring for 2 h, a vacuum of 20 mbar is applied until an acid number of less than 5 mg KOH/g is reached. 150 g of trimellitic anhydride are added to 1300 g of the polyester prepared, and stirring is effected for 1.5 h at 200° C. until an acid number of about 26 mg KOH/g is reached. The OH number is 56 mg KOH/g.

II.2.) Adduct Preparation and Transfer into the Aqueous Phase

The polyester is dissolved in acetone to give a 50% strength solution. The OH groups are reacted with a 1:1 adduct of isophorone diisocyanate and 2-hydroxyethyl acrylate, in the presence of 0.1% by weight of dibutyltin dilaurate, at 50° C., until an NCO number of less than 0.1% is reached. The adduct is diluted with acetone to a solids content of 50%. DMEA is then added (degree of neutralization 1.0). After addition of water with vigorous stirring, the acetone is distilled off. A storage-stable dispersion having a solids content of about 36%, a viscosity_{D=200} of 280 mPa·s and a pH of 8.2 is obtained.

### Example III

### Comparative Example

The polyester according to example II.1.) was transferred directly and without reaction with a further component into the aqueous phase. For this purpose, the polyester is diluted with acetone to a solids content of 50%. DMEA is then added (degree of neutralization 1.0). After addition of water with vigorous stirring, the acetone is distilled off. A storage-stable dispersion having a solids content of about 36% is obtained.

Characteristics:

Acid number: 27 mg KOH/g, viscosity_{D=200}: 280 mPa·s, pH: 8.4, solids content: 36.0%

The dispersions according to examples II. and III. are mixed with a polyurethane dispersion in ratios of 90/10, 80/20 and 70/30 (polyurethane dispersion/example dispersion) and provided with 3% of Darocur 1173 and applied to aluminum sheets, and the solvent is evaporated at elevated temperature (30 min, 80° C.). The films are then cured by means of UV light (medium-pressure mercury lamp, 70 W/optical filter 350 nm) for about 12 sec.

All films are resistant to premium grade gasoline and methyl ethyl ketone.

| | | König | | Erichsen | MEK test |
|---|---|---|---|---|---|
| | Mixing | hardness | Crosshatch | cupping | (double |
| Example | ratio | [s] | test | [mm] | strokes) |
| No | 100/0 | 66 | 4-5 | 8.0 | ˜100 |
| addition | | | | | |
| II. | 90/10 | 124 | 2 | 9.0 | >150 |
| | 80/20 | 148 | 1 | 9.5 | >150 |
| | 70/30 | 158 | 0 | 9.5 | >150 |
| Comparison | 90/10 | 81 | 3-4 | 9.0 | 95¹⁾ |
| III. | | | | | |
| | 80/20 | 86 | 3 | 9.0 | 95¹⁾ |
| | 70/30 | 92 | 3-4 | 9.0 | 100¹⁾ |

¹⁾swells

Crosshatch adhesion: DIN 53151
Erichsen cupping: DIN 53156
König pendulum hardness: DIN EN ISO 1522

1-52. (canceled)

53: An aqueous, unsaturated, amorphous polyester modified so as to be radiation-curable and substantially comprising
A) at least one unsaturated, amorphous polyester comprising at least one α,β-unsaturated dicarboxylic acid component and an alcohol component, the alcohol component comprising a dicidol mixture of the isomeric compounds 3,8-bis(hydroxymethyl)tricyclo[5.2.1.0^{2,6}]decane, 4,8-bis(hydroxymethyl)tricyclo[5.2.1.0^{2,6}]decane and 5,8-bis(hydroxymethyl)tricyclo[5.2.1.0^{2,6}]decane, it being possible for each isomer to be present in a proportion of from 20 to 40% in the mixture, and the sum of the three isomers being from 90 to 100%, characterized in that up to 10% of further isomers of dicidol and/or trimeric and/or higher isomeric diols of the Diels-Alder reaction product of cyclopentadiene being present, and the mixture being present in an amount of at least 5% in the alcohol components of the polyester,
and
B) at least one compound which has at least one ethylenically unsaturated group simultaneously having at least one group reactive toward A),
and
C) at least one compound having at least one hydrophilic and/or potentially hydrophilic group.

54: The aqueous, unsaturated, amorphous polyester modified so as to be radiation-curable as claimed in claim 53,
characterized by
a) a content of nonvolatile components of from 20 to 60%
b) a solvent content of from 0 to 20%
c) a viscosity at 20° C. of from 20 to 750 mPa·s.

55: The aqueous, unsaturated, amorphous polyester modified so as to be radiation-curable as claimed in claim 53, characterized in that the acid component additionally contains aromatic and/or aliphatic and/or cycloaliphatic monocarboxylic acids and/or dicarboxylic acids and/or polycarboxylic acids.

56: The aqueous, unsaturated, amorphous polyester modified so as to be radiation-curable as claimed in claim 53, characterized in that the acid component partly or completely comprises anhydrides and/or alkyl esters.

57: The aqueous, unsaturated, amorphous polyester modified so as to be radiation-curable as claimed in claim 53, characterized in that the alcohol component contains further linear and/or branched, aliphatic and/or cycloaliphatic and/or aromatic diols and/or polyols.

58: The aqueous, unsaturated, amorphous polyester modified so as to be radiation-curable as claimed in claim 53, characterized in that citraconic, fumaric, itaconic, maleic and/or mesaconic acid is contained as the α,β-unsaturated dicarboxylic acid.

59: The aqueous, unsaturated, amorphous polyester modified so as to be radiation-curable as claimed in claim 53, characterized in that phthalic acid, isophthalic acid, terephthalic acid, 1,4-cyclohexanedicarboxylic acid, succinic acid, sebacic acid, methyltetrahydrophthalic acid, methylhexahydrophthalic acid, hexahydrophthalic acid, tetrahydrophthalic acid, dodecanedioic acid, adipic acid, azelaic acid, pyromellitic acid and/or trimellitic acid, the acid anhydrides and/or methyl esters thereof and isononanoic acid and/or 2-ethylhexanoic acid are contained as additional acids.

60: The aqueous, unsaturated, amorphous polyester modified so as to be radiation-curable as claimed in claim 53, characterized in that ethylene glycol, 1,2- and/or 1,3-propanediol, diethylene, dipropylene, triethylene or tetraethylene glycol, 1,2- and/or 1,4-butanediol, 1,3-butylethylpropanediol, 1,3-methylpropanediol, 1,5-pentanediol, cyclohexanedimethanol, glycerol, hexanediol, neopentylglycol, trimethylolethane, trimethylolpropane and/or pentaerythritol, bisphenol A, B, C and F, norbornylene glycol, 1,4-benzyldimethanol and -ethanol and 2,4-dimethyl-2-ethylhexane-1,3-diol are contained as additional alcohols.

61: The aqueous, unsaturated, amorphous polyester modified so as to be radiation-curable as claimed in claim 53, characterized in that the alcohol component comprises at least 20% of the isomers as claimed in claim 53.

62: The aqueous, unsaturated, amorphous polyester modified so as to be radiation-curable as claimed in claim 53, characterized in that the alcohol component comprises at least 50% of the isomers as claimed in claim 53.

63: The aqueous, unsaturated, amorphous polyester modified so as to be radiation-curable as claimed in claim 53, characterized in that the alcohol component comprises at least 90% of the isomers as claimed in claim 53.

64: The aqueous, unsaturated, amorphous polyester modified so as to be radiation-curable as claimed in claim 53, characterized in that the alcohol component comprises 100% of the isomers as claimed in claim 53.

65: The aqueous, unsaturated, amorphous polyester modified so as to be radiation-curable as claimed in claim 53, characterized in that fumaric acid and/or maleic acid (anhydride) are contained as the α,β-unsaturated acid component.

66: The aqueous, unsaturated, amorphous polyester modified so as to be radiation-curable as claimed in claim 53, characterized in that the alcohol component is contained in the molar ratio of 0.5 to 2.0:1 relative to the acid component.

67: The aqueous, unsaturated, amorphous polyester modified so as to be radiation-curable as claimed in claim 53, characterized in that the alcohol component is contained in the molar ratio of 0.8 to 1.5:1 relative to the acid component.

68: The aqueous, unsaturated, amorphous polyester modified so as to be radiation-curable as claimed in claim 53, characterized in that the alcohol component is contained in the molar ratio of 1.0 to 1.1:1 relative to the acid component.

69: The aqueous, unsaturated, amorphous polyester modified so as to be radiation-curable as claimed in claim 53, characterized in that said polyester has an acid number of from 1 to 200 mg KOH/g.

70: The aqueous, unsaturated, amorphous polyester modified so as to be radiation-curable as claimed in claim 53, characterized in that said polyester has an OH number of from 1 to 200 mg KOH/g.

71: The aqueous, unsaturated, amorphous polyester modified so as to be radiation-curable as claimed in claim 53, characterized in that (meth)acrylic acid and/or derivatives thereof are used as component B).

72: The aqueous, unsaturated, amorphous polyester modified so as to be radiation-curable as claimed in claim 53, characterized in that (meth)acryloyl chloride, glycidyl (meth)acrylate, (meth)acrylic acid and/or the lower molecular weight alkyl esters and/or anhydrides thereof and hydroxyalkyl (meth)acrylates whose alkyl spacers have from 1 to 12.

73: The aqueous, unsaturated, amorphous polyester modified so as to be radiation-curable as claimed in claim 53, characterized in that isocyanates which have an ethylenically unsaturated group, are used as component B).

74: The aqueous, unsaturated, amorphous polyester modified so as to be radiation-curable as claimed in claim 53, characterized in that reaction products of hydroxyalkyl (meth)acrylates with alkyl spacers which have from 1 to 12, carbon atoms with diisocyanates are used as component B).

75: The aqueous, unsaturated, amorphous polyester modified so as to be radiation-curable as claimed in claim 53, characterized in that diisocyanates selected from cyclohexane diisocyanate, methylcyclohexane diisocyanate, ethylcyclohexane diisocyanate, propylcyclohexane diisocyanate, methyldiethylcyclohexane diisocyanate, phenylene diisocyanate, toluene diisocyanate, bis(isocyanatophenyl)methane, propane diisocyanate, butane diisocyanate, pentane diisocyanate, are used, alone or as mixtures.

76: The aqueous, unsaturated, amorphous polyester modified so as to be radiation-curable as claimed in claim 53, characterized in that polyisocyanates prepared by dimerization, trimerization, allophanatization, biuretization and/or urethanization of simple diisocyanates are used.

77: The aqueous, unsaturated, amorphous polyester modified so as to be radiation-curable as claimed in claim 53, characterized in that the reaction products of hydroxyethyl acrylate and/or hydroxyethyl methacrylate with isophorone diisocyanate (IPDI) and/or hexamethylene diisocyanate (HDI) and/or dicyclohexylmethane 4,4′-diisocyanate (H₁₂MDI) and/or a mixture of 2,2,4- and 2,4,4-trimethylhexamethylene diisocyanate in the molar ratio of 1:1 are used as component B).

78: The aqueous, unsaturated, amorphous polyester modified so as to be radiation-curable as claimed in claim 53, characterized in that from 2 to 100, % of the OH groups of component A) are reacted with component B).

79: The aqueous, unsaturated, amorphous polyester modified so as to be radiation-curable as claimed in claim 53, characterized in that at least one further component C) having at least one hydrophilic and/or potentially hydrophilic group is used for the hydrophilization.

80: The aqueous, unsaturated, amorphous polyester modified so as to be radiation-curable as claimed in claim 53, characterized in that a di-, tri- and/or polycarboxylic acid is used as component C) for the hydrophilization and is only partly reacted.

81: The aqueous, unsaturated, amorphous polyester modified so as to be radiation-curable as claimed in claim 53, characterized in that trimellitic acid (anhydride) is used as component C) for the hydrophilization and is only partly reacted.

82: The aqueous, unsaturated, amorphous polyester modified so as to be radiation-curable as claimed in claim 53, characterized in that a reaction product of a diisocyanate and a further polyol component are used as component C).

83: The aqueous, unsaturated, amorphous polyester modified so as to be radiation-curable as claimed in claim 53, characterized in that an aromatic, aliphatic and/or cycloaliphatic diisocyanate are used as the diisocyanate of component C).

84: The aqueous, unsaturated, amorphous polyester modified so as to be radiation-curable as claimed in claim 53, characterized in that isophorone diisocyanate (IPDI) and/or hexamethylene diisocyanate (HDI) and/or dicyclohexylmethane 4,4′-diisocyanate (H₁₂MDI) and/or a mixture of 2,2,4- and/or 2,4,4-trimethylhexamethylene diisocyanate (TMDI) are used as the diisocyanate of component C).

85: The aqueous, unsaturated, amorphous polyester modified so as to be radiation-curable as claimed in claim 53, characterized in that amino acids, hydroxysulfonic acids, aminosulfonic acids and/or hydroxycarboxylic acids are used as further polyol component of component C).

86: The aqueous, unsaturated, amorphous polyester modified so as to be radiation-curable as claimed in claim 53, characterized in that dimethylolpropionic acid and/or 2-[(2-aminoethyl)amino]ethanesulfonic acid or derivatives thereof are used as further polyol component of component C).

87: The aqueous, unsaturated, amorphous polyester modified so as to be radiation-curable as claimed in claim 53, characterized in that adducts of dimethylolpropionic acid and/or 2-[(2-aminoethyl)amino]ethanesulfonic acid or derivatives thereof and IPDI and/or H₁₂MDI and/or HDI and/or TMDI in the molar ratio 1:2 are used as component C).

88: The aqueous, unsaturated, amorphous polyester modified so as to be radiation-curable as claimed in claim 53, characterized in that auxiliaries and additives are contained.

89: The aqueous, unsaturated, amorphous polyester modified so as to be radiation-curable as claimed in claim 53, characterized in that auxiliaries and additives selected from inhibitors, organic solvents, neutralizing agents, surface-active substances, oxygen scavengers and/or free radical scavengers, catalysts, light stabilizers, color brighteners, photosensitizers, photoinitiators, thixotropic agents, antiskinning agents, antifoams, antistatic agents, thickeners, thermoplastic additives, dyes, pigments, fireproof treatments, internal lubricants, fillers and/or blowing agents are contained.

90: The aqueous, unsaturated, amorphous polyester modified so as to be radiation-curable as claimed in claim 53, characterized in that the alcohol component for the preparation of component A) comprises at least 90% of dicidol mixture as claimed in claim 53, and fumaric acid and/or maleic acid (anhydride) is present in the diol/acid ratio of 0.9 to 1.1:1.

91: The aqueous, unsaturated, amorphous polyester modified so as to be radiation-curable as claimed in claim 53, characterized in that dodecanedioic acid, trimellitic acid (anhydride), adipic acid and/or phthalic acid (anhydride) are additionally contained as the acid component in a ratio of α,β-unsaturated additional acid from 3:1 to 1:4.

92: The aqueous, unsaturated, amorphous polyester modified so as to be radiation-curable as claimed in claim 53, characterized in that at least a part of the acid groups of the unsaturated, amorphous polyester modified so as to be radiation-curable is neutralized.

93: The aqueous, unsaturated, amorphous polyester modified so as to be radiation-curable as claimed in claim 53, characterized in that an amine and/or an inorganic alkali is used for the neutralization.

94: The aqueous, unsaturated, amorphous polyester modified so as to be radiation-curable as claimed in claim 53, characterized in that the degree of neutralization is from 0.3 to 1.3.

95: A process for the preparation of aqueous, unsaturated, amorphous polyesters modified so as to be radiation-curable and substantially comprising
A) at least one unsaturated, amorphous polyester comprising at least one α,β-unsaturated dicarboxylic acid component and an alcohol component, the alcohol component comprising a dicidol mixture of the isomeric compounds 3,8-bis(hydroxymethyl)tricyclo[5.2.1.0^{2,6}]decane, 4,8-bis(hydroxymethyl)tricyclo[5.2.1.0^{2,6}]-decane and 5,8-bis(hydroxymethyl)tricyclo[5.2.1.0^{2,6}]decane, it being possible for each isomer to be present in a proportion of from 20 to 40% in the mixture, and the sum of the three isomers being from 90 to 100%, and the mixture being present in an amount of at least 5% in the alcohol components of the polyester,
and
B) at least one compound which has at least one ethylenically unsaturated group simultaneously having at least one group reactive toward A),
and
C) at least one compound having at least one hydrophilic and/or potentially hydrophilic group,
by reaction of the starting components for the preparation of component A) at a temperature of from 150 to 270° C. and subsequent reaction with the components C) and B) or the components B) and C) in the melt or in solution in a suitable, organic solvent at temperatures of from 20 to 230° C.

96: The process for the preparation of aqueous, unsaturated, amorphous polyesters modified so as to be radiation-curable as claimed in claim 95, characterized in that the reaction is effected in an inert gas atmosphere.

97: The process for the preparation of aqueous, unsaturated, amorphous polyesters modified so as to be radiation-curable as claimed in claim _, characterized in that the inert gas has an oxygen content of less than 50 ppm.

98: The process for the preparation of aqueous, unsaturated, amorphous polyesters modified so as to be radiation-curable as claimed in claim 95, characterized in that starting components as claimed in claim 95 are used.

99: The process for the preparation of aqueous, unsaturated, amorphous polyesters modified so as to be radiation-curable as claimed in claim 95, characterized in that the reaction product of components A), B) and C) is dispersed in water, optionally with the use of an organic auxiliary solvent.

100: The process for the preparation of aqueous, unsaturated, amorphous polyesters modified so as to be radiation-curable as claimed in claim 95, characterized in that the organic auxiliary solvent is optionally distilled off.

101: The method of using an aqueous, unsaturated, amorphous polyesters modified so as to be radiation-curable as claimed in claim 95 in aqueous, radiation-curable systems.

102: The method of using an aqueous, unsaturated, amorphous polyesters modified so as to be radiation-curable as claimed in claim 95, as the main component, base component or additional component in aqueous coating materials, adhesives, laminations, printing inks and inks, polishes, glazes, pigment pastes, filling compounds, cosmetic articles, packaging materials and/or sealing compounds and insulating materials.

103: An article which was finished with aqueous, unsaturated, amorphous polyesters modified so as to be radiation-curable as claimed in claim 95.
